(19) United States
(12) Patent Application Publication
(10) Pub. No.: US 2011/0035536 A1
(43) Pub. Date: Feb. 10, 2011

(54) NON-VOLATILE MEMORY DEVICE GENERATING WEAR-LEVELING INFORMATION AND METHOD OF OPERATING THE SAME

(75) Inventors: Hojun Shim, Seoul (KR); Je-Hyuck Song, Seoul (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/732,316

(22) Filed: Mar. 26, 2010

(30) Foreign Application Priority Data
Aug. 6, 2009 (KR) 1020090072529

(51) Int. Cl. G06F 12/02; G06F 12/00

(52) U.S. Cl. 711/103; 711/E12.001; 711/E12.008

(57) ABSTRACT

A non-volatile memory device which includes a non-volatile memory core including a memory cell array and a controller configured to generate wear-leveling information from internal operation information of the memory cell array after a write operation, independent of a request from an external device. The wear-leveling information is selectively provided to the external device.

### CROSS-REFERENCE TO RELATED APPLICATIONS

A claim of priority is made under 35 U.S.C. §119 to Korean Patent Application No. 10-2009-0072529 filed Aug. 6, 2009, in the Korean Intellectual Property Office, the subject matter of which is hereby incorporated by reference.

### BACKGROUND

The present inventive concept relates to a semiconductor memory device, and more particularly, the present inventive concept relates to a flash memory device.

Non-volatile memory devices can be electrically erased and programmed, and retain stored data even when powered off. Non-volatile memory devices may include various types of memory cell transistors, divided into NOR type and NAND type, according to cell array structures. In particular, a NAND-type non-volatile memory device has a cell string structure in which memory cell transistors are connected in series, making the NAND-type non-volatile memory device highly integrated. Further, since the NAND-type non-volatile memory device is able to simultaneously change information stored in multiple memory cell transistors, information stored in the NAND-type non-volatile memory device may be updated rapidly. Accordingly, NAND flash memory devices, which are NAND-type non-volatile memory devices, are utilized in various applications necessitating mass-media storage, such as MP3 players, digital cameras, Solid-State Drives (SSDs), and the like.

In general, a user accesses a NAND flash memory device via a file system, a host driver and a memory controller. Since the NAND flash memory device does not support a data overwrite function, an erase operation is carried out prior to a program operation for a write operation. Since a program-erase cycle of the NAND flash memory device is limited, a wear-leveling technique may be applied to distribute use of the memory cell transistors, which affects system lifetime.

### SUMMARY

An aspect of the inventive concept is directed to a non-volatile memory device, which includes a non-volatile memory core including a memory cell array and a controller configured to generate wear-leveling information from internal operation information of the memory cell array after a write operation, independent of a request from an external device. The wear-leveling information is selectively provided to the external device.

Another aspect of the inventive concept is directed to an operating method of a non-volatile memory device, which includes executing a write operation of a selected memory region of the non-volatile memory device in response to a write command, and determining wear-leveling information from internal operation information of the selected memory region after executing the write operation. The determined wear-leveling information is output in response to an external request.

Still another aspect of the inventive concept is directed to a memory system, which includes a non-volatile memory device and a memory controller configured to control the non-volatile memory device. The non-volatile memory device is configured to determine wear-leveling information from internal operation information of a write-requested memory region and to provide the determined wear-leveling information to the memory controller in response to a wear-leveling request of the memory controller.

### BRIEF DESCRIPTION OF THE FIGURES

Exemplary embodiments of the inventive concept will be described with reference to the attached drawings, in which like reference numerals refer to like parts throughout the various drawings unless otherwise specified.

FIG. 1 is a block diagram schematically showing a memory device, according to an exemplary embodiment of the inventive concept.

FIG. 2 is a block diagram schematically showing an internal information controller illustrated in FIG. 1, according to an exemplary embodiment of the inventive concept.

FIG. 3 is a block diagram schematically showing a memory device, according to an exemplary embodiment of the inventive concept.

FIG. 4 is a block diagram schematically showing a main controller/high voltage generator block illustrated in FIG. 3, according to an exemplary embodiment of the inventive concept.

FIG. 5 is a block diagram schematically showing a memory system including a memory device, according to an exemplary embodiment of the inventive concept.

FIG. 6 is a flowchart for describing a program operation of a memory device, according to an exemplary embodiment of the inventive concept.

FIG. 7 is a flowchart for describing an erase operation of a memory device, according to an exemplary embodiment of the inventive concept.

FIG. 8 is a block diagram schematically showing another memory system including a memory device, according to an exemplary embodiment of the inventive concept.

### DETAILED DESCRIPTION OF THE EMBODIMENTS

Various embodiments of the inventive concept will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments. In the drawings, sizes and relative sizes of elements and regions may be exaggerated for clarity. Also, throughout the drawings and written description, like reference numerals will be used to refer to like or similar elements.

It will be understood that, although the terms first, second, third, etc., may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the scope of the present teachings.

Spatially relative terms, such as “beneath”, “below”, “lower”, “under”, “above”, “upper” and the like, may be used herein for ease of description to describe one element or feature's relationship to another element(s) or feature(s), as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. Likewise, if the device is otherwise oriented (rotated 90 degrees or at other orientations), the spatially relative descriptors used herein would be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

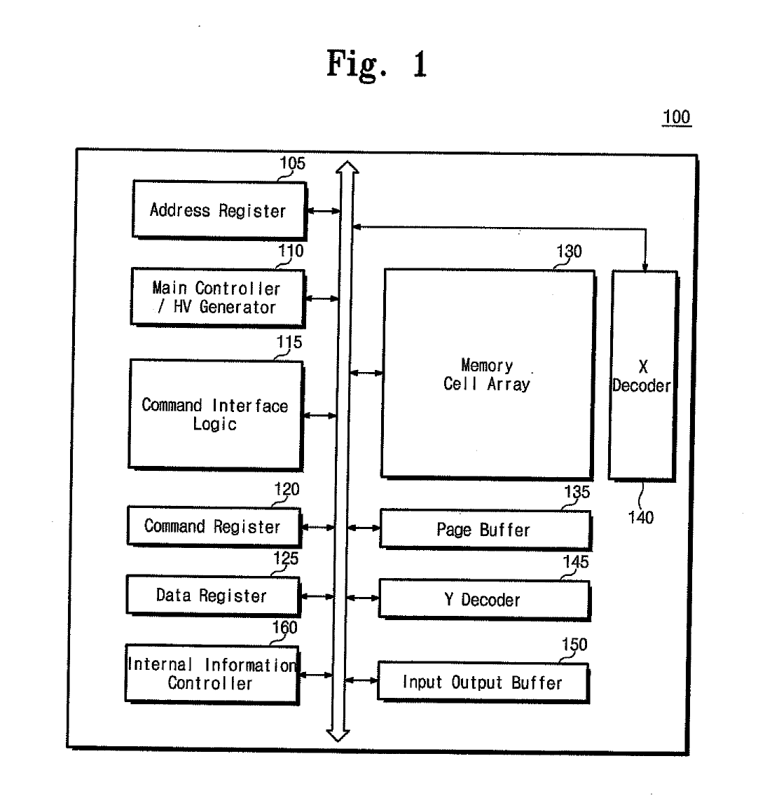

FIG. 1 is a block diagram schematically showing a memory device, according to an exemplary embodiment of the inventive concept.

A flash memory device 100 may be a NAND flash memory device according to an exemplary embodiment, although the inventive concept is not limited to NAND flash memory devices in various alternative exemplary embodiments. For example, the inventive concept may be applied to non-volatile memory devices, such as a NOR flash memory device, phase-change random access memory (PRAM), ferroelectric random access memory (FRAM), magnetoresistive random access memory (MRAM), and the like.

Referring to FIG. 1, the flash memory device 100 includes an address register 105, a main controller/high voltage generator block 110, command interface logic 115, a command register 120, a data register 125, a memory cell array 130, a page buffer 135, a row decoder 140, a column decoder 145, and an input/output buffer 150, which constitutes a memory core. In the depicted embodiment, the flash memory device 100 further includes an internal information controller 160.

The address register 105 may transfer a row or column address to a decoder using a signal received via the input/output buffer 150. The decoder may include the row and column decoders 140 and 145, for example.

The main controller/high voltage generator block 110, which may be referred to as the “first controller,” may conduct operations of controlling the flash memory device 100 and generating various internal timing and high voltage signals in response to operations (for example, commands) requested of the flash memory device 100. The commands may include a program command, an erase command, a read command, and the like.

The command interface logic 115 may determine whether signals received via the input/output buffer 150 are a command, an address or data, based on external control signals. The external control signals may include a Chip Enable (CE#) signal, an Address Latch Enable (ALE) signal, a Command Latch Enable (CLE) signal, a Write Enable (WE#) signal, a Read Enable (RE#) signal, and the like.

The command register 120 may transfer a command to a main controller using signals received via the input/output buffer 150. The data register 125 may transfer data to the page buffer 135 using signals received via the input/output buffer 150.

The memory cell array 130 is the region in which data are stored. The memory cell array 130 includes multiple memory cells, each of which may have a charge storing layer such as a floating gate, a charge trap layer, and the like. The page buffer 135 is configured to read data from the memory cell array 130 and to program data in the memory cell array 130.

The row decoder 140 may decode a row address received via the address register 105 to select word lines of the memory cell array 130. The column decoder 145 may decode a column address received via the address register 105 to select bit lines of the memory cell array 130, that is, registers/latches in the page buffer 135. The input/output buffer 150 is configured to interface with an external device (not shown).

The internal information controller 160 (which may be referred to as the “second controller”) is configured to process wear-leveling information of the flash memory device 100. In various embodiments, the internal information controller 160 may be physically separate (e.g., in hardware) from the main controller/high voltage generator block 110 for controlling an overall operation of the flash memory device 100. That is, the internal information controller 160 may be configured as an independent controller for processing wear-leveling information of the flash memory device 100.

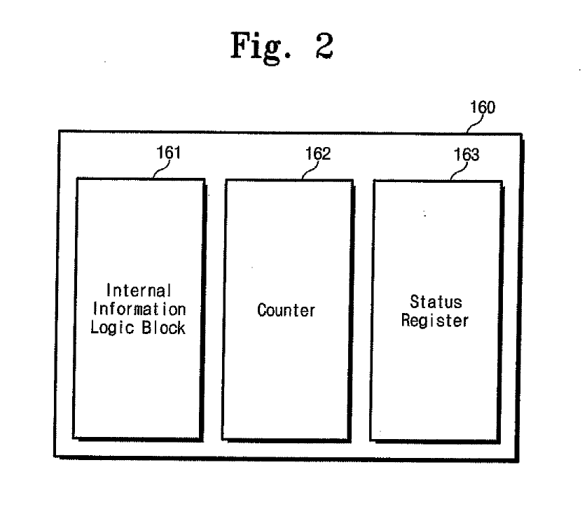

FIG. 2 is a block diagram schematically showing the internal information controller 160 illustrated in FIG. 1, according to an exemplary embodiment of the inventive concept. The internal information controller 160 will be more fully described with reference to FIGS. 1 and 2.

In accordance with a write operation, the flash memory device 100 may perform a program operation by page unit and an erase operation by block unit. The erase operation may be performed prior to the program operation.

Memory cells in the flash memory device 100 may be formed of cell transistors, each having a charge storage layer, such as a floating gate, a charge trap layer, and the like. For example, when a charge storage layer is formed of a floating gate, the cell transistor includes a tunnel oxide film, a floating gate for storing data and a control gate for controlling the floating gate, stacked over an active region.

As program/erase cycles are repeated, the tunnel oxide film begins to wear out, which negatively affects characteristics of the flash memory device 100. For example, wear of the tunnel oxide film may cause loss of stored data, increased operating times, and decreased capacitance of the flash memory device 100.

In order to increase reliably of the flash memory device 100 over a long period of time, it is desirable to use the pages and/or blocks uniformly within the memory system, for example, using a wear-leveling technique. The wear-leveling technique may require acquisition of wear-leveling information, indicating the condition of the pages and blocks in the flash memory device 100 with respect to wear. In the depicted embodiment, the wear-leveling information is generated by the internal information controller 160, for example, based on internal operation information of the flash memory device 100.

Referring to FIG. 2, the internal information controller 160 includes an internal information logic block 161 configured to process internal operation information, a counter 162 and a status register 163. For example, the internal operation information may include information related to Incremental Step Pulse Program (ISPP) used in program operations and Incremental Step Pulse Erase (ISPE) used in erase operations.

With ISPP, a program voltage applied to a word line is increased incrementally by a given step until a program operation is complete. Memory cells are programmed using the program voltage. With ISPE, an erase voltage applied to a doped well formed at a semiconductor substrate is incrementally increased by a given step until an erase operation is complete. Memory cells are erased using the erase voltage.

In accordance with an exemplary embodiment, in a program operation, the number of applied program pulses (or voltages) for programming a worn page is less than the number of applied program pulses for programming a non-worn page. Further, a program time for programming the worn page is shorter than a program time for programming a non-worn page.

In a program operation, some of the electrons moving between the active region and the floating gate may be trapped at the tunnel oxide film of a worn memory cell, due to deterioration of the tunnel oxide film. The trapped electrons may act as electrons stored in the floating gate, thus decreasing the number of applied program pulses/voltages. As the number of applied program pulses/voltages decreases (or, when the number (or loop number) is reduced for generating a program voltage being increased stepwise), the program time becomes shorter. The number of applied program pulses and/or the page program time may be utilized as internal operation information.

In accordance with an exemplary embodiment, in an erase operation, the number of applied erase pulses (or voltages) for erasing a worn block increases, as compared to the number of applied erase pulses for erasing a non-worn block. Further, an erase time for erasing a worn block is longer than an erase time for erasing a non-worn block.

In an erase operation, some of the electrons moving between the active region and the floating gate may be trapped at the tunnel oxide film of the worn memory cell due to deterioration of the tunnel oxide film. The trapped electrons may act as electrons stored in the floating gate, thus increasing the number of applied program pulses/voltages. As the number of applied erase pulses/voltages increases (or, when the number (or loop number) is increased for generating an erase voltage being increased stepwise), the erase time becomes longer. The number of applied erase pulses and/or the block erase time may be utilized as internal operation information.

The internal operation information is collected using the counter 162 of the internal information controller 160. The device for collecting the internal operation information may include another device capable of confirming the number or time. The collected internal operation information may be processed by the internal information logic block 161 of the internal information controller 160 to be expressed as wear-leveling information indicating the degree of wear. For example, the wear-leveling information may express levels or degrees of wear as “very low”, “low”, “normal”, “high” and “very high”.

For example, in a program operation, a stepwise increased program voltage may be applied to a selected page up to about 30 times until the program operation is complete. In this case, when the program voltage is applied to the selected page less than 5 times, for example, the wear-leveling information may indicate “very high” wear. In the event that the program voltage is applied to a selected page more than 5 times and less than 10 times, the wear-leveling information may indicate “high” wear. In the event that the program voltage is applied to a selected page more than 10 times and less than 15 times, the wear-leveling information may indicate “normal” wear. When the program voltage is applied to a selected page more than 15 times and less than 20 times, the wear-leveling information may indicate “low” wear. When the program voltage is applied to a selected page more than 20 times, the wear-leveling information may indicate “very low” wear. That is, the wear-leveling information may be expressed by a class.

In an embodiment, internal operation information utilized by the internal information logic block 161 may be wear-leveling information, which is not processed by the internal information logic block 161. For example, it is possible to utilize internal operation information, such as a number of applied program/erase pulses or a page program/block erase time collected by the counter 162, without processing.

The wear-leveling information may be provided or output externally from the flash memory device 100 via the status register 163 of the internal information controller 160. The size of the register 163 may be changed according to the amount of the wear-leveling information. Means for externally providing the wear-leveling information may include a device capable of expressing information.

In an exemplary embodiment, the wear-leveling information in the register 163 may be provided externally in response to a wear-leveling status read command.

The wear-leveling status read command may be identical to a status read command executed in a program or erase operation. Status information may be provided externally from the flash memory device 100, for example, when a read enable signal RE# is toggled after an input of the status read command. In this case, the toggling of the RE# signal may be varied to avoid collision between a status output request after a program or erase operation and a status output request according to the wear-leveling status read command. For example, the RE# signal may be toggled several times.

It is possible to set the wear-leveling status read command to be different from a status output command executed in a program or erase operation. In this case, a new wear-leveling status output command may be produced.

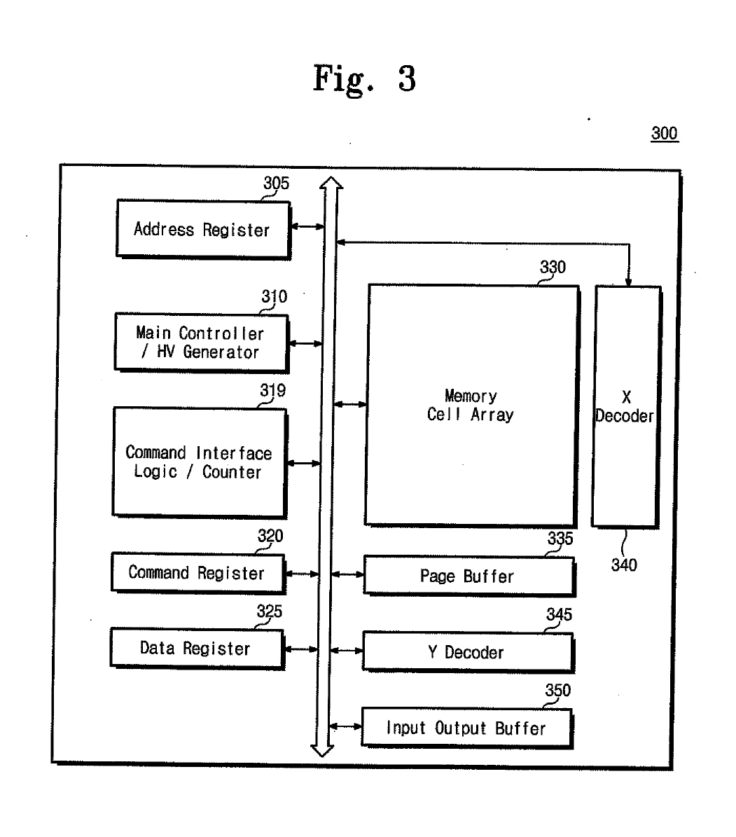

FIG. 3 is a block diagram schematically showing a memory device, according to another exemplary embodiment of the inventive concept.

Referring to FIG. 3, a flash memory device 300 includes an address register 305, a main controller/high voltage generator block 310, a command interface logic and counter block 319, a command register 320, a data register 325, a memory cell array 330, a page buffer 325, a row decoder 340, a column decoder 345, and an input/output buffer 350, which constitute a memory core.

The elements of the flash memory device 300 other than the main controller/high voltage generator block 310 and the command interface logic and counter block 319 are the same as the corresponding elements shown in FIG. 1, described above. Accordingly, the descriptions of these elements, i.e., the address register 305, the command register 320, the data register 325, the memory cell array 330, the page buffer 325, the row decoder 340, the column decoder 345, and the input/output buffer 350, will not be repeated.

The command interface logic and counter block 319 functionally includes a command interface logic block and a counter block. The command interface logic block determines whether signals received via the input/output buffer 350 are a command, an address or data, based on external control signals. The external control signals may include a Chip Enable (CE#) signal, an Address Latch Enable (ALE) signal, a Command Latch Enable (CLE) signal, a Write Enable (WE#) signal, a Read Enable (RE#) signal, and the like. The counter block is configured to count signals generated within the flash memory device 300, where the counted signals may include internal operation information.

Wear-leveling information may be produced by the main controller/high voltage generator block 310 (which may be referred to as the “first controller”) based on the internal operation information of the flash memory device 300. This will be more fully described below.

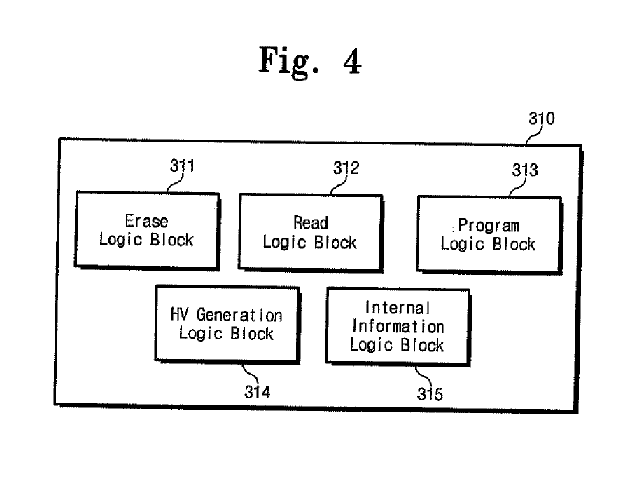

FIG. 4 is a block diagram schematically showing the main controller/high voltage generator block illustrated in FIG. 3, according to an exemplary embodiment of the inventive concept.

Referring to FIG. 4, the main controller/high voltage generator block 310 includes an erase logic block 311, a read logic block 312, a program logic block 313, a high voltage generation logic block 314, and an internal information logic block 315.

The erase logic block 311 may generate various internal timing signals in response to an erase command. The read logic block 312 may generate various internal timing signals in response to a read command. The program logic block 313 may generate various internal timing signals in response to a program command. The high voltage generation logic block 314 may generate a high voltage in response to an erase command and a program command. The internal information logic block 315 may produce wear-leveling information based on internal operation information of the flash memory device 300.

In an exemplary embodiment, internal operation information may be collected using the counter block of the command interface logic and counter block 319. A device for collecting the internal operation information may include another device capable of confirming the number or time. The collected internal operation information may be processed by the internal information logic block 315 of the main controller/high voltage generator block 310 to be expressed as wear-leveling information.

As described above with reference to the internal information logic block 161, the internal operation information processed by the internal information logic block 315 may be wear-leveling information which the internal information logic block 315 processes. For example, the wear-leveling information may express levels or degrees of wear as “very low”, “low”, “normal”, “high” and “very high”.

For example, in an erase operation, a stepwise increased erase voltage can be applied to a selected block up to about 30 times until the erase operation is complete. In this case, when the erase voltage is applied to a selected block less than 5 times, for example, the wear-leveling information may indicate “very low” wear. In the event that the erase voltage is applied to a selected block more than 5 times and less than 10 times, the wear-leveling information may indicate “low” wear. In the event that the erase voltage is applied to a selected block more than 10 times and less than 15 times, the wear-leveling information may indicate as “normal” wear. When the erase voltage is applied to a selected block more than 15 times and less than 20 times, the wear-leveling information may indicate “high” wear. When the erase voltage is applied to a selected block more than 20 times, the wear-leveling information may indicate “very high” wear. That is, the wear-leveling information may be expressed by a class.

Alternatively, internal operation information processed by the internal information logic block 315 may be wear-leveling information which is not processed by the internal information logic block 315. For example, it is possible to utilize internal operation information, such as an ISPP or ISPE applied number and a page program/block erase time collected by the counter block of the command interface logic and counter block 319, without processing.

The wear-leveling information may be output or provided externally from the flash memory device 300 via the data register 325. The size of the data register 325 may be changed according to the amount of wear-leveling information. Means for providing the wear-leveling information to the external may include a device capable of expressing information.

In an exemplary embodiment, the wear-leveling information in the data register 325 may be provided externally in response to a wear-leveling status read command. The wear-leveling status read command may be identical to a status read command executed in a program or erase operation. That is, wear-leveling information may be output from the flash memory device 300 when a read enable signal RE# is toggled after an input of the status read command.

Alternatively, the wear-leveling status read command may be set to be different from a status output command executed in a program or erase operation. In this case, a new wear-leveling status output command may be produced.

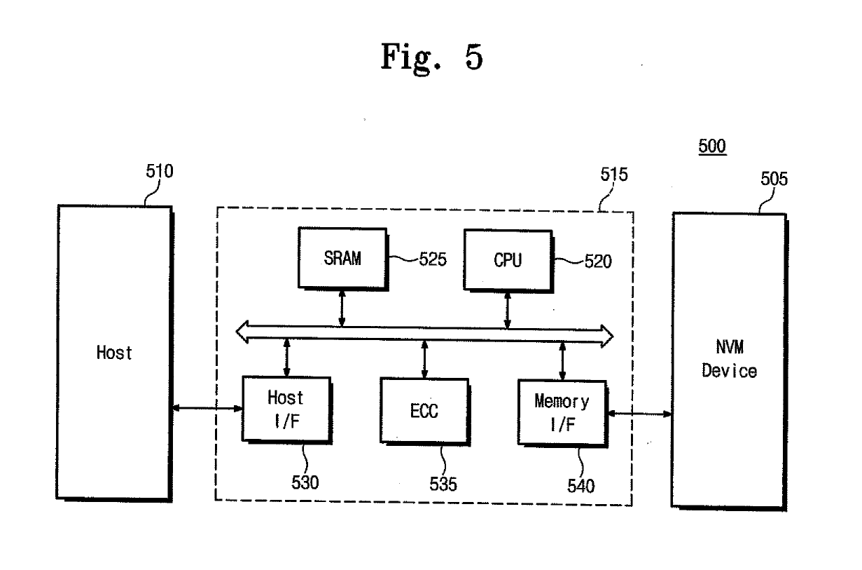

FIG. 5 is a block diagram schematically showing a memory system including a memory device, according to an exemplary embodiment of the inventive concept.

Referring to FIG. 5, a memory system 500 for providing large-volume data storing capacity includes a non-volatile memory device 505, which may include a flash memory device 100 or 300, as illustrated in FIG. 1 or FIG. 3, respectively, according to exemplary embodiments.

A memory controller 515 of the memory system 500 may be configured to control data exchange between the non-volatile memory device 505 and a host 510. Central processing unit (CPU) 520 may control an overall operation of the memory controller 515.

Static random access memory (SRAM) 525 may be used as a working memory of the CPU 520. A host interface 530 includes the data exchange protocol for interfacing between the host 510 and the memory system 500. ECC 535 may be configured to detect and correct errors in data read out from a multi-level cell (MLC) non-volatile memory device 505. A memory interface 540 is configured to interface with the non-volatile memory device 505.

Although not shown in figures, the memory system 500 may further include read only memory (ROM), as would be appreciated by one of ordinary skill in the art, which stores code data for interfacing with the host 510.

A user of flash memory devices 100 and 300 according to exemplary embodiments of the inventive concept may access a flash memory device via a file system, a host driver and a memory controller.

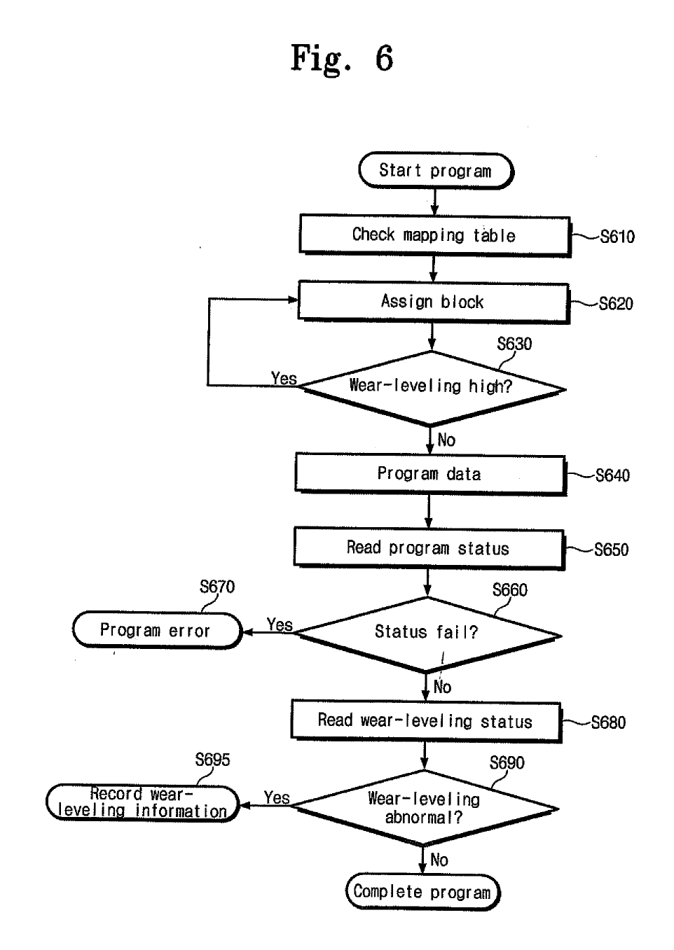

FIG. 6 is a flowchart for describing a program operation of a memory device, according to an exemplary embodiment of the inventive concept. An operation of a flash memory device will be more fully described below with reference to the accompanying drawings.

In steps S610 and S620 of FIG. 6, a mapping table is checked and a page or a block of the flash memory device, in which the data are to be programmed, is assigned. In step S630, a memory controller searches wear-leveling information of the assigned page or block to determine the amount or degree of wear-leveling of the assigned page or block. The wear-leveling information may be information obtained from a previously executed program or erase operation, for example. The wear-leveling information may be information stored in the flash memory device or in a working memory of the memory controller. When the degree of wear of the assigned page or block is determined to be high, the process returns to step S620 and a new page or block may be assigned again.

When the degree of wear of the assigned page or block is determined not to be high, the flash memory device executes a data program operation with respect to the assigned page or block in step S640. For example, the memory controller may send a program command, an address and data to the flash memory device. The flash memory device may store the sent data in a selected page or block. In the event that the flash memory device executes a program operation using an ISPP scheme, internal operation information, such as a step increase number of ISPP or a program end time, may be collected using a counter. The collected information may be processed by an internal information logic block to be used as wear-leveling information.

Further, the memory controller may check a ready/busy signal R/B# indicating an operating status of the flash memory device until the program operation is ended.

In step S650, the memory controller issues a status output command to the flash memory device to read the program status. The flash memory device may provide status information to the memory controller in response to a toggle of a read enable signal RE#, for example.

In step S660, the memory controller checks whether the program operation has failed or has been executed normally, based on the status information. When the program operation is determined to have failed, the program operation is treated as a program error in step S670. When the program operation is determined not to have failed, the process proceeds to step S680.

In an exemplary embodiment, the memory controller issues a wear-leveling status output command to the flash memory device in step S680. The flash memory device may provide wear-leveling information to the memory controller in response to a toggle of a read enable signal RE#, for example.

In step S690, the memory controller determines the degree to which the assigned page or block is worn out, based on the wear-leveling information, by determining whether the wear-leveling is abnormal. When the degree of wear-leveling is determined to be normal, the program operation is complete. When the degree of wear-leveling is determined to be abnormal, the wear-leveling information is recorded in step S695. Wear-leveling information thus recorded may be referred to during page or block assignment in program or erase operations subsequently executed. This may be accomplished, for example, by reducing an assignment number of a worn-out page or block or by not assigning the worn-out page or block, under the control of the memory controller or software of the memory system, for example.

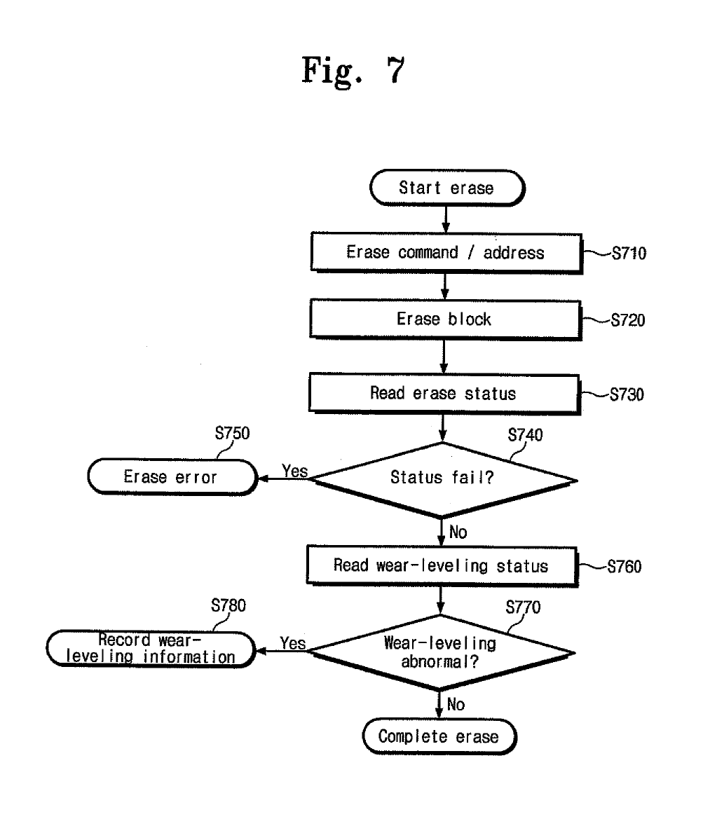

FIG. 7 is a flowchart for describing an erase operation of a memory device, according to an exemplary embodiment of the inventive concept. An operation of a flash memory device will be more fully described below with reference to the accompanying drawings.

In step S710, a memory controller sends an erase command and an address to the flash memory device. In step S720, the flash memory device executes an erase operation by erasing the corresponding block. In the event that the flash memory device executes an erase operation according to an ISPE scheme, internal operation information, such as a step increase number of ISPE or an erase end time, may be collected using a counter, for example. The collected information may be processed by an internal information logic block to be used as wear-leveling information.

Further, the memory controller may check a ready/busy signal R/B# indicating an operating status of the flash memory device until the erase operation has ended.

In step S730, the memory controller issues a status output command to the flash memory device to read the erase status. The flash memory device may provide status information to the memory controller in response to a toggle of a read enable signal RE#, for example.

In step S740, the memory controller checks whether the erase operation has failed or has executed normally, based on the status information. When the erase operation is determined to have failed, the erase operation is treated as an erase error in step S750.

In an exemplary embodiment, the memory controller issues a wear-leveling status output command to the flash memory device in step S760. The flash memory device may provide wear-leveling information to the memory controller in response to a toggle of a read enable signal RE#, for example.

In step S770, the memory controller determines the degree to which the erased block is worn out, based on the wear-leveling information, by determining whether the wear-leveling is abnormal. When the degree of wear-leveling is determined to be normal, the erase operation is complete. When the degree of wear-leveling is determined to be abnormal, the wear-leveling information is recorded in step S780. Wear-leveling information thus recorded may be referred to during page or block assignment in program or erase operations subsequently executed. This may be accomplished, for example, by reducing an assignment number of a worn-out page or block, or by not assigning the worn-out page or block, under the control of the memory controller or software of the memory system, for example.

In an exemplary embodiment, the wear-leveling technique may be used with respect to pages or blocks having endurance characteristics that are not good due to process variations. The endurance characteristics include the persistence with respect to a program/erase cycle. A page or block having deteriorated endurance characteristics due to process variations may experience a sharp increase in the degree of wear-leveling, even though program or erase operations are not executed as frequently.

On the other hand, a flash memory device according to an exemplary embodiment of the inventive concept may be configured to actively produce wear-leveling information internally, without an external request. This makes it possible to reduce a search operation for a page or block which is becoming worn. Accordingly, it is possible to reduce the search time and simplify the operation.

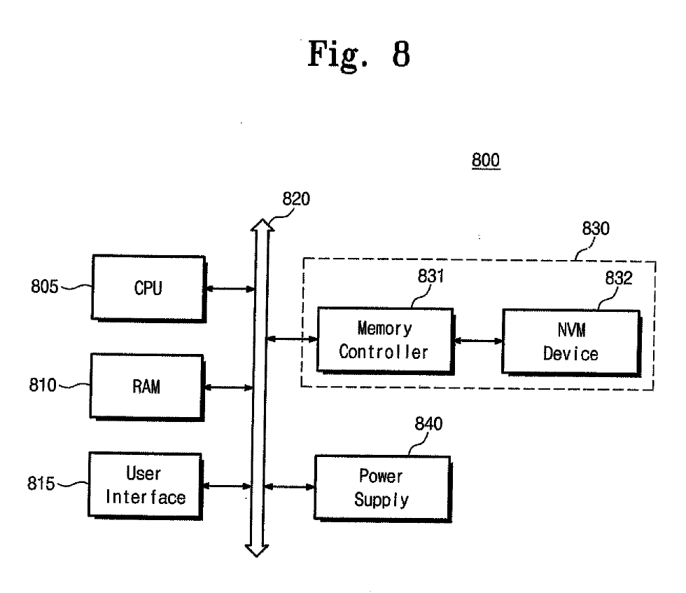

FIG. 8 is a block diagram schematically showing another memory system including a memory device, according to an exemplary embodiment of the inventive concept.

Referring to FIG. 8, a memory system 800 includes CPU 805, RAM 810, user interface 815, system bus 820, non-volatile memory system 830, and power supply 840.

The non-volatile memory system 830 electrically connected to the CPU 805, the RAM 810, the user interface 815, and the power supply 840, e.g., via the system bus 820. In the depicted embodiment, the non-volatile memory system 830 includes a memory controller 831 and a non-volatile memory device 832. The non-volatile memory device 832 may be a flash memory device, according to an exemplary embodiment of the inventive concept. Data provided via the user interface 815 and/or processed by the CPU 805 may be stored in the non-volatile memory device 832 through memory controller 831.

Although not shown in the figures, the memory system may further include an application chipset, camera image processor, and the like, as would be apparent to one of ordinary skill in the art.

A flash memory device and/or a memory controller according to various exemplary embodiments of the inventive concept may be packed according to various types of packages such as PoP (Package on Package), Ball grid arrays (BGAs), Chip Scale Packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi-Chip Package (MCP), Wafer-level Fabricated Package (WFP), Wafer-Level Processed Stack Package (WSP), and the like.

While the present inventive concept has been described with reference to exemplary embodiments, it will be apparent to those skilled in the art that various changes and modifications may be made without departing from the spirit and scope of the present teachings. Therefore, it should be understood that the above embodiments are not limiting, but illustrative.

What is claimed is:

1. A non-volatile memory device, comprising:
a non-volatile memory core comprising a memory cell array; and
a controller configured to generate wear-leveling information from internal operation information of the memory cell array after a write operation, independent of a request from an external device, the wear-leveling information being selectively provided to the external device.

2. The non-volatile memory device of claim 1, wherein the write operation includes a program operation and an erase operation.

3. The non-volatile memory device of claim 1, wherein the non-volatile memory core further comprises a first controller configured to process an operation of the non-volatile memory core and the wear-leveling information.

4. The non-volatile memory device of claim 3, wherein the non-volatile memory core further comprises a second controller configured to process the wear-leveling information of the memory cell array, the second controller being in hardware separate from the first controller.

5. The non-volatile memory device of claim 4, wherein either the first controller or the second controller is configured to determine the wear-leveling information of the memory cell array based on a stepwise increased program step pulse in a program operation.

6. The non-volatile memory device of claim 4, wherein either the first controller or the second controller is configured to determine the wear-leveling information of the memory cell array based on a stepwise increased erase step pulse in an erase operation.

7. The non-volatile memory device of claim 1, wherein the wear-leveling information includes at lease one of a number of a stepwise increased program step pulse, a number of a stepwise increased erase step pulse, and a wear-leveling degree.

8. An operating method of a non-volatile memory device, comprising:
executing a write operation of a selected memory region of the non-volatile memory device in response to a write command; and
after executing the write operation, determining wear-leveling information from internal operation information of the selected memory region,
wherein the determined wear-leveling information is output in response to an external request.

9. The operating method of claim 8, wherein the write command comprises a program command and an erase command.

10. A memory system, comprising:
a non-volatile memory device; and
a memory controller configured to control the non-volatile memory device,
wherein the non-volatile memory device is configured to determine wear-leveling information from internal operation information of a write-requested memory region and to provide the determined wear-leveling information to the memory controller in response to a wear-leveling request of the memory controller.

11. The memory system of claim 10, wherein the non-volatile memory device comprises:
a non-volatile memory core having a memory cell array; and
a controller configured to process wear-leveling information of the memory cell array.

12. The memory system of claim 11, wherein the controller is configured to process the wear-leveling information from the internal operation information of the write-requested memory region, the processed wear-leveling information being provided to the memory controller in response to a request of the memory controller.
